(19) United States
(12) Patent Application Publication
(10) Pub. No.: US 2026/0222281 A1
(43) Pub. Date: Jul. 30, 2026

(54) DETECTING WHETHER A NETWORK IS EXPERIENCING A CAPACITY LIMITATION

(71) Applicant: Telefonaktiebolaget LM Ericsson (publ), Stockholm (SE)

(72) Inventors: Ulf LINDGREN, Västra Frölunda (SE); Tamas KORBELYI, Budapest (HU); Adam SUHREN GUSTAFSSON, Göteborg (SE); Luis Eduardo BARRAGAN RUANO, Düsseldorf (DE); Maciej WISZNIEWSKI, Kaarst (DE); Adam WIREHED, Göteborg (SE)

(73) Assignee: Telefonaktiebolaget LM Ericsson (publ), Stockholm (SE)

(21) Appl. No.: 19/146,628

(22) PCT Filed: Jan. 12, 2023
(86) PCT No.: PCT/EP2023/050581

§ 371 Date: Jul. 9, 2025

(51) Int. Cl. H04L 41/0681; H04W 24/04; H04W 24/08

(52) U.S. Cl. CPC H04L 41/0681; H04W 24/04; H04W 24/08

(57) ABSTRACT

A method (1100) for detecting whether a network is experiencing a capacity limitation. The method includes obtaining a first set of data points, wherein each data point in the first set of data points is a throughput value for a network node. The method also includes, based on the first set of data points, calculating a first threshold value. The method also includes determining a number of data points (M) in the first set of data points which are greater than the first threshold value. The method also includes determining that a criteria is satisfied. The method also includes, as a result of determining that the criteria is satisfied, providing an indication (e.g., transmitting an alarm message) indicating the network is experiencing a capacity limitation, wherein determining that the criteria is satisfied comprises determining that M satisfies a first condition.

### TECHNICAL FIELD

Disclosed are embodiments related to detecting whether a network is experiencing a capacity limitation.

### BACKGROUND

A radio access network (RAN) will typically include multiple nodes (e.g., Radio Base Stations (RBS)), each of which receives data from a core network (CN) and transmits data over the air to one or more user equipments (UEs) using a Radio Access Technology (RAT) (e.g., Wideband Code Division Multiple Access (WCDMA), Long Term Evolution (LTE) or New Radio (NR)). Data received at a RAN node from a UE is transmitted from the RAN node to a network node (e.g., gateway or user plane function) in a CN (e.g., an LTE or 5G core network). The connection between a RAN node and the CN can be for example an optical fiber or a wireless link. This connection is referred to as a backhaul connection (or backhaul for short).

A RAN node is capable of serving a number of UEs simultaneously. The number of UEs that can be served depends on the node's transmission capacity, measured in bits per second (bps). However, if the backhaul is limiting the transport of bits, the node will be capacity limited. An example of a limiting factor can be an old radio link used as the backhaul. The node itself has a good capacity of say 1500 Mbps whereas the backhaul only can transport data in speeds up to say 200 Mbps. Hence, the node is capacity limited by its backhaul.

### SUMMARY

Certain challenges presently exist. For example, equipment (a.k.a., devices) in a network may not always operate at their throughput capacity due to inefficiencies in the network. A network operator, however, may be unaware that equipment in the network is operating at a limited capacity. Before the operator can bring the network to peak performance, they must first be aware of the limitation. As such, a process is needed to indicate when equipment in the network may be operating at a limited capacity.

Accordingly, in one aspect there is provided a method for detecting whether a network is experiencing a capacity limitation. The method includes obtaining a first set of data points. Each data point in the first set of data points is a throughput value for a network node. The method also includes, based on the first set of data points, calculating a first threshold value. The method also includes determining a number of data points (M) in the first set of data points which are greater than the first threshold value. The method also includes determining that a criteria (the criteria may include one or more criterions) is satisfied. The method also includes as a result of determining that the criteria is satisfied, providing an indication (e.g., transmitting an alarm message) indicating the network is experiencing a capacity limitation. Determining that the criteria is satisfied comprises determining that M satisfies a first condition.

In some aspects, there is provided a computer program comprising instructions which when executed by processing circuitry of an apparatus (e.g., network node) causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is an increase in data throughput of a limited network by detecting a capacity limitation condition. Detecting when a device is limited is crucial to understanding when to act to achieve a better performance in the network. The embodiments described herein may be applicable in multiple situations, for example, in an S1 interface in telecommunication or in a subnet of a LAN or VLAN.

### BRIEF DESCRIPTION OF THE DRAWINGS

The accompanying drawings, which are incorporated herein and form part of the specification, illustrate various embodiments.

FIG. 1 illustrates a network according to an embodiment.

FIG. 2 illustrates a block diagram according to an embodiment.

FIG. 3 illustrates a block diagram according to an embodiment.

FIGS. 4A-4C illustrate graphs according to an embodiment.

FIGS. 5A-5C illustrate graphs according to an embodiment.

FIGS. 6A and 6B illustrate graphs according to an embodiment.

FIG. 7 illustrates graphs according to an embodiment.

FIGS. 8A and 8B illustrate graphs according to an embodiment.

FIG. 9 illustrates graphs according to an embodiment.

FIG. 10 is a flowchart illustrating a process according to an embodiment.

FIG. 11 is a flowchart illustrating a process according to an embodiment.

FIG. 12 is a block diagram of a node according to an embodiment.

### DETAILED DESCRIPTION

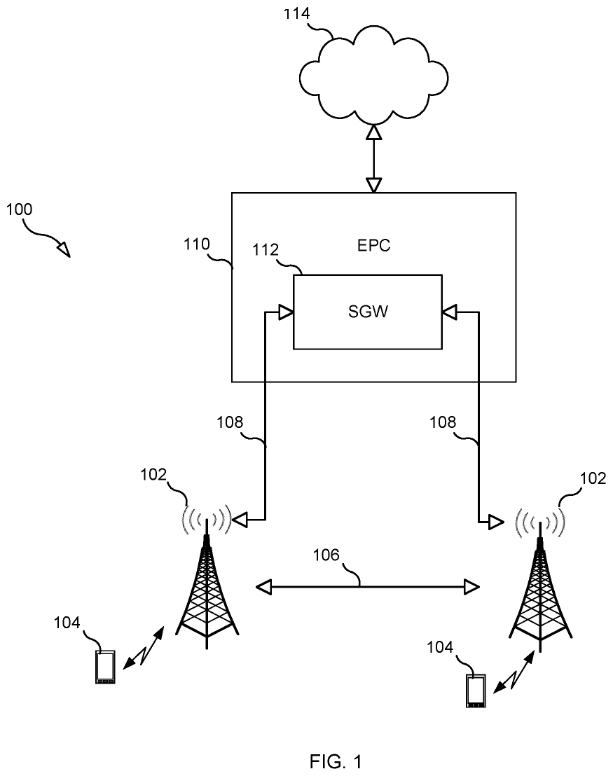

FIG. 1 illustrates a network 100, according to an embodiment, whose network capacity may be limited. The network 100 includes multiple RAN nodes 102 (or “nodes 102” for short) in wireless communication with one or more UEs 104. The UEs 104 may be configured to transmit signal(s) over the air towards the nodes 102, and the nodes 102 may be configured to receive the over-the-air signal(s) transmitted by the UEs 104. Additionally or alternatively, the nodes 102 may be configured to transmit signal(s) over-the-air towards the UEs 104, and the UEs 104 may be configured to receive the over-the-air signal(s) transmitted by the nodes 102. In some embodiments, the network 100 may be embodied as a 4G (Long-Term Evolution (LTE)) network or 5G (New Radio (NR)) network and the nodes 102 may be embodied as 4G base stations (eNBs) or 5G base stations (gNBs). The number of UE(s) and the number of node(s) shown in FIG. 1 are provided for simple explanation purpose only and do not limit the embodiments of this disclosure in any way.

The nodes 102 may communicate with each other using inter node communication 106. The inter node communication 106 may be embodied as the 3rd Generation Partnership Project (3GPP) X2 interface. The nodes 102 may also communicate with nodes in a core network 110 via a backhaul (e.g., a 3GPP S1 interface). In this example, core network 110 is an Evolved Packet Core that includes a Serving Gateway (SGW). The core network 110 may connect to an external network 114, such as the internet.

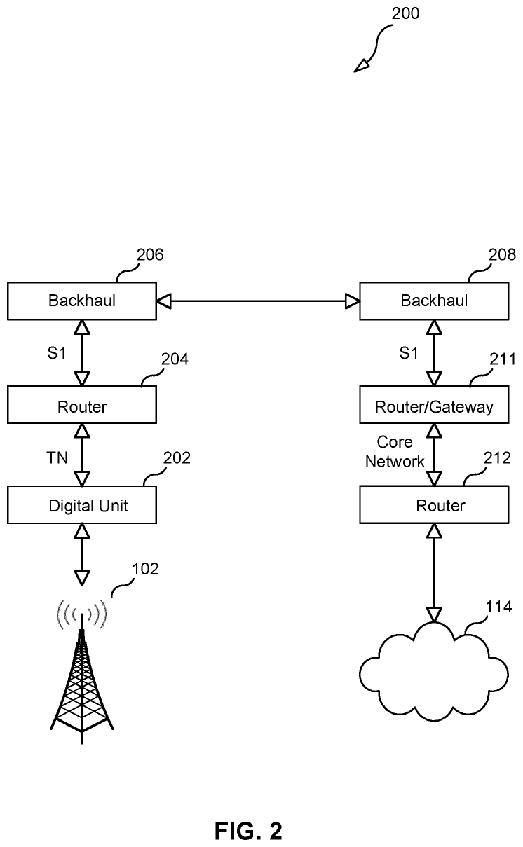

FIG. 2 illustrates a block diagram showing a connection from node (left) to internet (right) transporting data over a backhaul connection consisting of a communication link. On the left side of FIG. 2, the node 102 includes a digital unit (DU) 202. The DU 202 may contain multiple functions including baseband processing. The baseband capacity is the maximum throughput which the baseband processing can handle and will set a node's limit. The DU 202 also connects the Radio Units (RUs) on a site, and it provides ports for the X2 and S1 interfaces. The S1 interface may carry the user plane data, for example the data sent during a web-browsing session in a UE. As such, S1 information may be transported via the backhaul 206.

In some embodiments, the DU 202 may contain several ports which can be configured to connect to the TN via a backhaul 206. In such embodiments, more than one port can be connected to the backhaul 206 allowing for load balancing. Load balancing or redundant TN is termed Link Aggregation Group (LAG). In FIG. 2, transmission TN may include multiple port assignments TN x and TN y where x and y signify the port names, respectively. These and other ports from the DU 202 are connected to a router/firewall 204 routing data to appropriate addresses. One or more addresses define the backhaul 206 on which the S1 traffic is sent. In some embodiments, the backhaul 206 may be embodied as a radio link.

The right-hand side of FIG. 2 depicts the core network, omitting the EPC functions, and its connection to the external network 114 (e.g., internet). The core network may include a backhaul 208, a router/gateway 211, and a router 212. The transmissions between backhaul 206 of the node and backhaul 208 of the EPC can consist of several jumps, that is, several different stretches with different equipment. Hence, the backhaul 206 can consist of several parts and the part with the least throughout capacity may be a limiting factor.

In some embodiments, the node 102 is monitored using configuration management (CM) and performance monitoring (PM) information. The CM and PM data may represent attributes and counters, respectively. An attribute is semi static information like baseband capacity. A counter is counting/recording time varying information like numbers of users or data throughput. In some embodiments, the counter may count the number of packets a digital unit is receiving from a router.

The sampling rate of attributes may vary. In some embodiments, the sampling rate may be once every 24 hours and counter every 15 minutes. The sampling rate of the counter may be termed Result Output Period (ROP). In the embodiments disclosed herein a detection of capacity limited nodes can be done based on CM and PM data. The location for such detector may reside in a cloud environment but may also reside in any other part of the network.

The embodiments described herein provide a method that can be used to detect whether the node is operating at full capacity. The limited capacity in some embodiments may be caused by backhauls with a lower throughput capacity. If the node itself is overloaded, it can be detected too by using counters for dropped packages.

The information for equation (1) is obtained using counters. In some embodiments, the counters are found in the Managed Object (MO)-class EthernetPort. In equation (1), the counters for packages are related to broadcast, multicast and unicast, internally in the DU is here termed cast packages or

$${I}_{CP} = if HCInBroadcastPkts + ifHC InMulticastPkts + ifH CInUcastPkts \qquad ( 1 )$$

where if HCInBroadcastPkts is the number of broadcast packets, ifHCInMulticastPkts is the number of multicast packets, ifHCInUcastPkts is the number of unicast packets, and I_{CP} is the ingress package count. The ingress packages not counted in I_{CP} is here termed Overhead Ingress (I_{OH}) or

$${I}_{OH} = if InErrors + ifInUnknownProtos + ifInUnknownTags + ifInDiscards \qquad ( 2 )$$

where ifInErrors is the number of inbound packets which contain errors preventing delivery, ifInUnknownProtos is the number of packets which were discarded because of an unknown or unsupported protocol, ifInUnknownTags is the number of packets discarded because they belong to an unknown virtual local area network (VLAN), and ifInDiscards is the number of inbound packets which were chosen to be discarded even though no error was detected to prevent delivery. The total frame ingress throughput in packets per second is

$${F}_{Tot} = \frac{{I}_{CP} + {I}_{OH}}{{T}_{ROP}} , \qquad ( 3 )$$

where T_{ROP} is the number of seconds per ROP. In some embodiments, T_{ROP} may be 900 seconds. In the equations above, both I_{CP} and I_{OH} is sampled for the duration of a ROP period.

In the present embodiment, a package is assumed to have twenty octets, denoted N_{PByte}=20, and the octet is eight bits, denoted N_{bits}=8. The peak rate of the Ethernet interface is

$${G}_{ETH , Peak} = \frac{{N}_{b i t s}}{1000000} ( ifInOctetRateMax + {N}_{PByte} {F}_{Tot} ) , \qquad ( 4 )$$

where ifInOctetRateMax is the 100th percentile (maximum value) of octets per second on the Ethernet interface measured during a ROP.

In equation (4), the first term, ifInOctetRateMax, represents the maximum bytes per second, Bps, on the Ethernet interface and the second term, N_{PByte} F_{Tot}, is the total frame ingress per second times the frame size. The sum is multiplied by eight to get bits per second and divided by 10⁶ to get the result in Mbps.

The baseband capacity may also be found in CM data in the attributes of the MO-class BbProcessingResource. Here the used attribute used is dlBbCapacityNet and the limit is given in Mbps.

### Theoretical Aspects on Limitation

The problem of capacity limited nodes can be described and understood from a mathematical standpoint. In the present section a simple model will be elaborated on. The model can be used for further investigation, primarily to design an optimal or asymptotically optimal model.

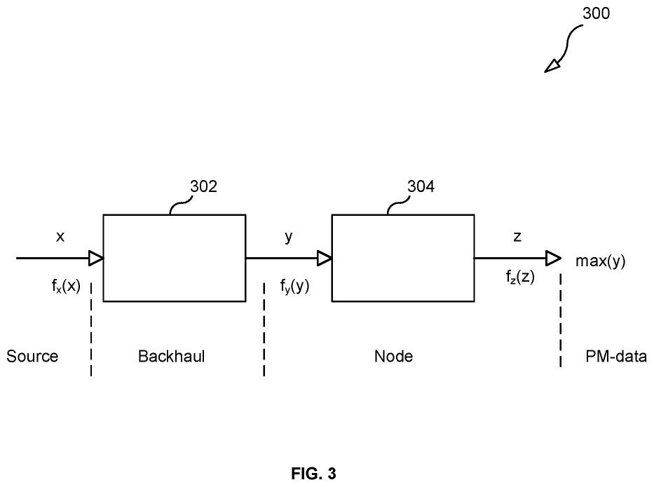

FIG. 3 illustrates a block diagram 300 showing the transformation of throughput measurements. Beginning on the left side of FIG. 3, a random variable x represents a measure of a throughput of a data stream. The random variable is distributed accordingly to a probability density function (PDF) fₓ (x). The left-hand side of FIG. 3 can be thought of as a domain prior to the backhaul, the source domain.

The data x is next transported via the backhaul 302 which limits the source data to a maximum throughput G_{L}. After passing the backhaul 302 a new random variable y is observed this too representing a measure of the data throughput. The distribution of the throughput after the backhaul 302 is f_{y} (y).

Finally, to the right, data is handled in the node 304. In some embodiments, one measurement of the throughput is taken every second, during the ROP, and sorted. A selection of these values is made and reported, one of the selected values of the reported values represent the maximum throughput measure recorded during the ROP. Hence, in FIG. 3 the output, in terms of PM data, is the maximum value and once more it represents a random variable z with the pdf f_{z} (z).

The remainder of the present section will elaborate on the distributions f_{y}(y) and f_{z} (z) in terms of the distribution fₓ(x). A system that uses an input, say x, changes its output, y depending on its system function. In the present embodiment, it will be assumed that the system function is memoryless.

There are two main approaches for the transformation of random variables in a memoryless system. The first approach uses the probability density function, and the second approach uses the cumulative distribution function, here denoted by a lower case and a capital letter, respectively. The issue is that there is no known well-established distribution on the source side. Nevertheless, any distribution can be used, and the transformation carried out.

Referring back to FIG. 3, the limiter of the backhaul 302 provides the following:
if y<0 then g(x)≤y for no values of x, implies F_{y} (y)=0.
if 0≤y<G_{L} then g(x)≤y for x≤y, implies F_{y} (y)=Fₓ (x).
if y≥G_{L} then g(x)≤y for all x, implies F_{y} (y)=1.

x is the input throughput into the backhaul 302. y is the output throughput of the backhaul and y=g(x). g(x) is a function representing the backhaul's 302 ability to process throughput data. The backhaul 302 may have a maximum throughput limit G_{L}. In this embodiment, the distribution function, F_{y}(y) after the limiter contains a jump. The size of that jump depends on how much of the probability mass of the input is above G_{L}.

This jump can be exploited as an indicator of a saturated throughput. However, returning to FIG. 3 and the node 304 portion to the right a list of sorted throughput measurements is created every ROP. In some embodiment, the list contains 900 measurements, that is one per second for 15 minutes.

In general, the distribution and density can be expressed for the k:th value, the general expression for the density is

$${f}_{x , k} ( x ) = \frac{n !}{( k - 1 ) ! ( n - k ) !} {F}_{x}^{k - 1} ( x ) {( 1 - {F}_{x} ( x ) )}^{n - k} {f}_{x} ( x ) \qquad ( 5 )$$

where n is the list length also corresponding to the position of the maximum value and k the list position of interest. The expressions for the density and distribution of the maximum value, position n, are

$${f}_{z} ( z ) = n {F}_{y}^{n - 1} ( z ) {f}_{y} ( z ) \qquad ( 6 a )$$

$$and$$

$${F}_{z} ( z ) = {( {F}_{y} ( z ) )}^{n} \qquad ( 6 b )$$

respectively. The limiting function in FIG. 3 produces a sharp transition that creates a Dirac in the density function. In some embodiments, the list in the node has 900 elements and this means that the resulting distribution, equation (6b), is a power of that number. Hence, only values close to one will remain.

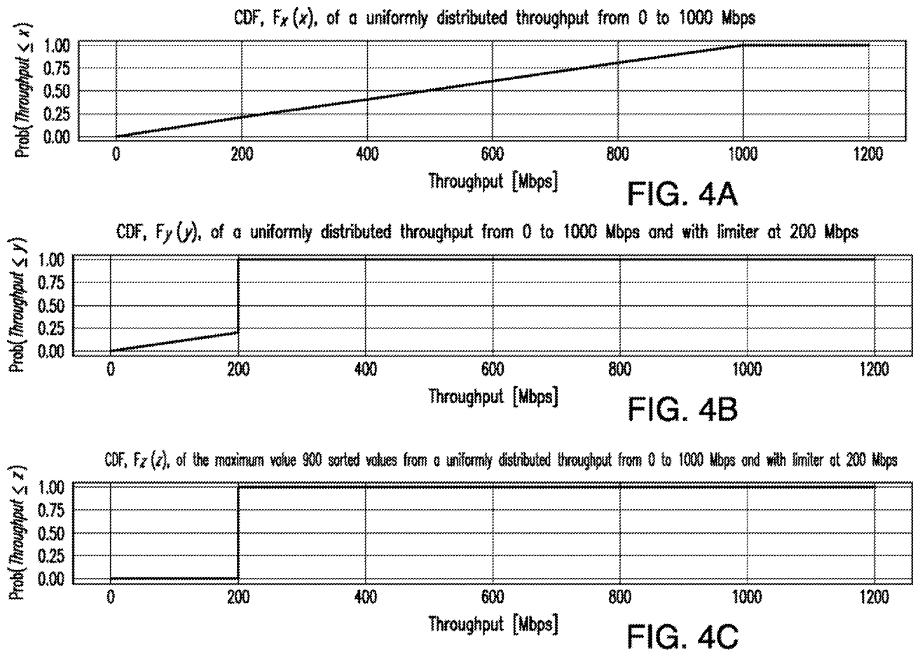

FIGS. 4A-4C illustrate graphs showing the cumulative density functions (CDFs) of fₓ(x), f_{y}(y), and f_{z} (z) of FIG. 3 with a uniform distributed throughput from 0 to 1000 Mbps.

FIG. 4A shows the CDF of fₓ(x) of with uniformly distributed throughput from 0 to 1000 Mbps. FIG. 4B shows the CDF of f_{y}(y) of a uniformly distributed throughput from 0 to 1000 Mbps and with a limitation at 200 Mbps. FIG. 4C shows the CDF of f_{z} (z) which depicts the max distribution of 900 samples from the limited measurements. Referring to FIG. 4B, assume that fₓ(x) is a uniform density, U(0, 1000) and that G_{L}=200 then

$${F}_{y} ( y ) = \frac{y}{1000} ( H ( y ) - H ( y - 200 ) ) + H ( y - 200 ) \qquad ( 7 )$$

where H(·) is the step function. Raising this function to the power of 900 result in

$${F}_{z} ( z ) = {( {F}_{y} ( z ) )}^{900} = {( \frac{z}{1000} )}^{900} ( H ( z ) - H ( z - 200 ) ) + H ( z - 200 ) \approx H ( z - 200 ) \qquad ( 8 )$$

In other embodiments, real world, non-uniform, data may result in softer clipping then as seen in FIG. 4B.

Looking at the Cumulative Density Functions (CDFs) obtained F_{z}(z) it appears as if a log-like distribution is an appropriate candidate for throughput measurements. However, collecting the highest throughput measure for each ROP during a period and then computing the CDF will be a good indicator of a backhaul with limitations. Especially, since the CDF is focused on the limit, like equation (8) indicates.

### A Method to Determine the Capacity Limited Nodes

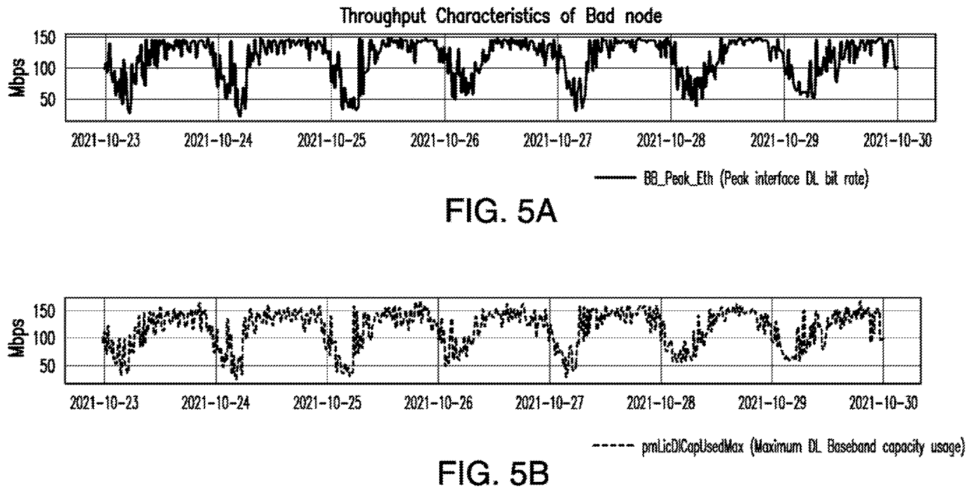

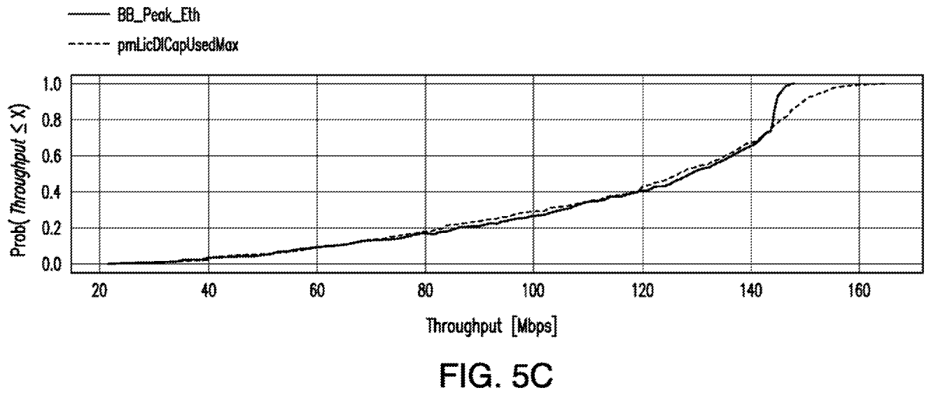

FIGS. 5A-5C illustrate graphs which depict DL throughput characteristics for a node. FIG. 5A illustrates a graph showing the max DL throughput of the Ethernet port. FIG. 5B illustrates a graph showing the DL throughput of the baseband. FIG. 5C illustrates a graph showing an estimate of the CDF of the graphs in FIGS. 5A and 5B.

The graph in FIG. 5A shows the ethernet port where throughput is limited. The graph in FIG. 5B depicts the baseband throughput which is not capped to the same degree. Turning to the graph of FIG. 5C, it is clearly seen that the throughput capacity of the Ethernet port is limited to about 145 Mbps.

Clearly, the node is limited by its backhaul since the transport capacity peaks at 145 Mbps and the node baseband can handle more than twice that capacity. It is important to note that the baseband capacity does not exhibit a clear limitation in throughput, meaning that using the PM-counter pmLicDICapUsedMax the problem is less obvious. The reason for this is that the data is buffered and consumed differently by the baseband than is the Ethernet port.

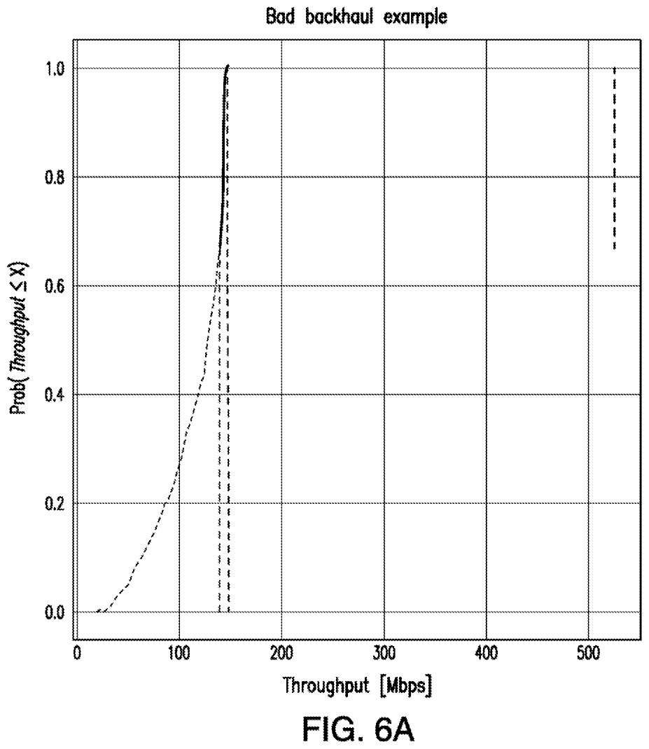

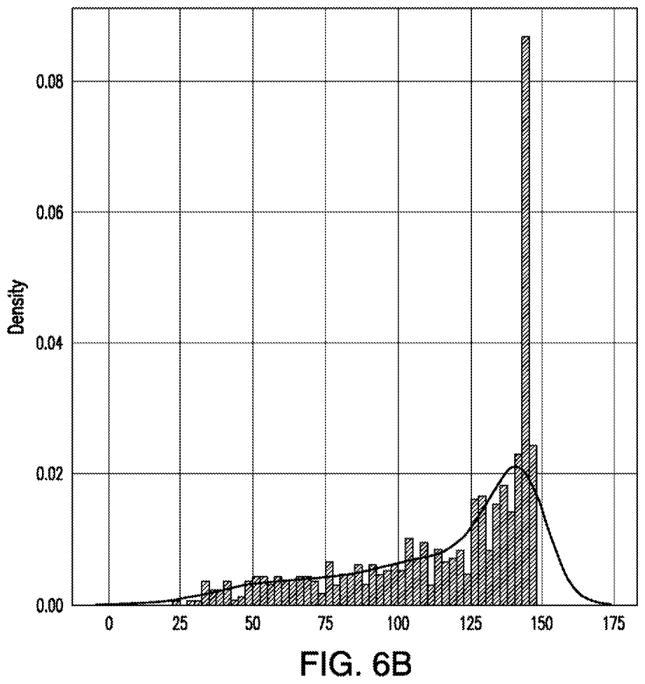

In FIG. 5C the CDF is depicted, and it exhibits a saturation characteristic where the curve becomes almost vertical. FIGS. 6A and 6B illustrates a more detailed view of the node. FIG. 6A illustrates a graph depicting the CDF where the throughput observations above 0.95% of the maximum observation. Gₘₐₓ, is emphasized. The node throughput capacity, Cₘₐₓ, is shown as a black dashed vertical line in the upper right corner. The two gray dashed vertical lines shows the interval [0.95Gₘₐₓ, Gₘₐₓ] and the emphasized part of the CDF in-between, equal to

$$Pro b ( z \geq 0.95 {G}_{max} ) \approx \frac{1}{3} .$$

FIG. 6B illustrates a graph which depicts the histogram of the counter ifInOctetRateMax (the maximum value for each ROP) and an estimate of the throughput pdf.

The variable studied in FIGS. 5A-C is the Ethernet port maximum throughput. The emphasized part, of FIG. 6A contains approximately 33% of all data points and represents throughputs greater than 95% of the maximum throughput, which indicates a limiting throughput rate. The vertical dashed line on the right of FIG. 6A represents the node's baseband capacity. FIG. 6B is an estimate of the throughput pdf, where it is clear that the throughput distribution is skewed towards higher throughput values as shown in the FIG. 6A.

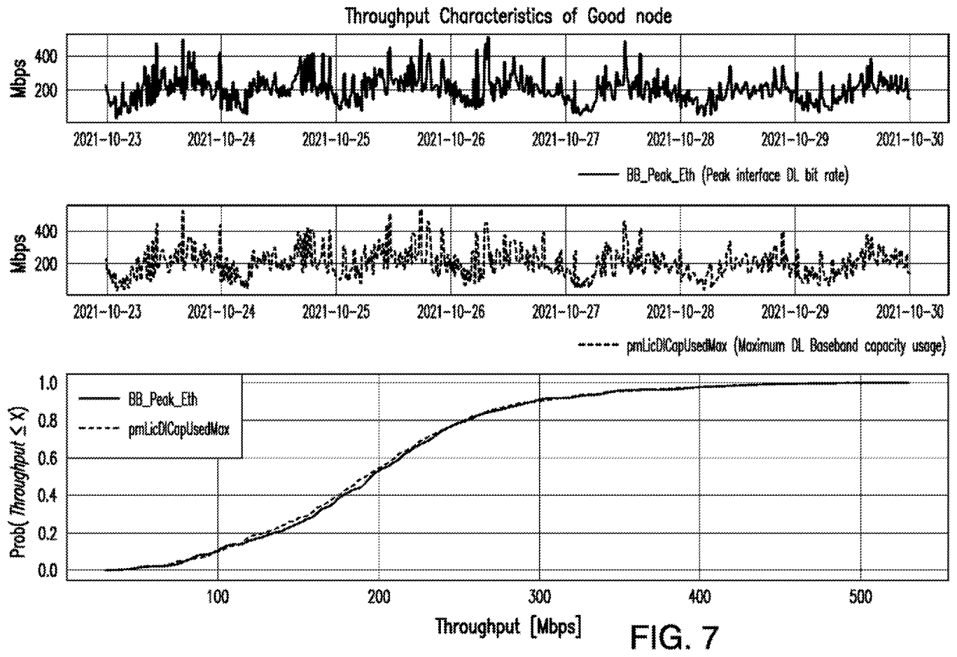

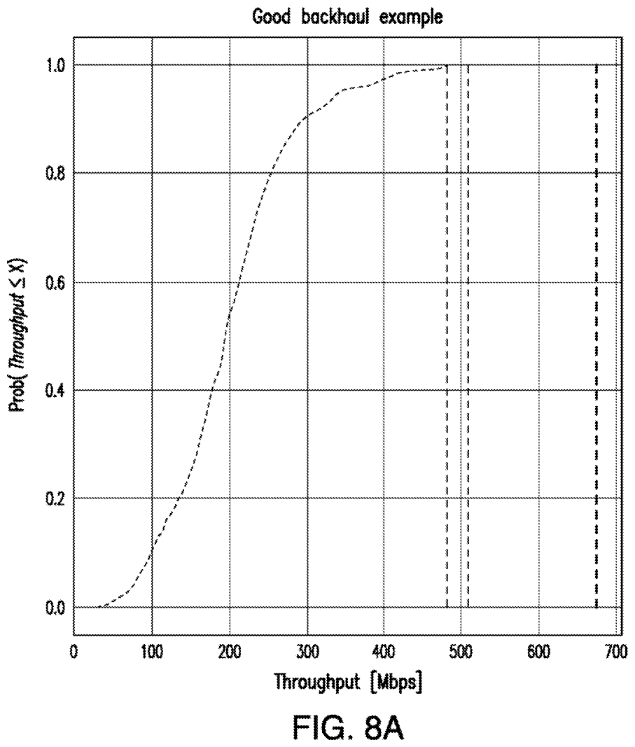

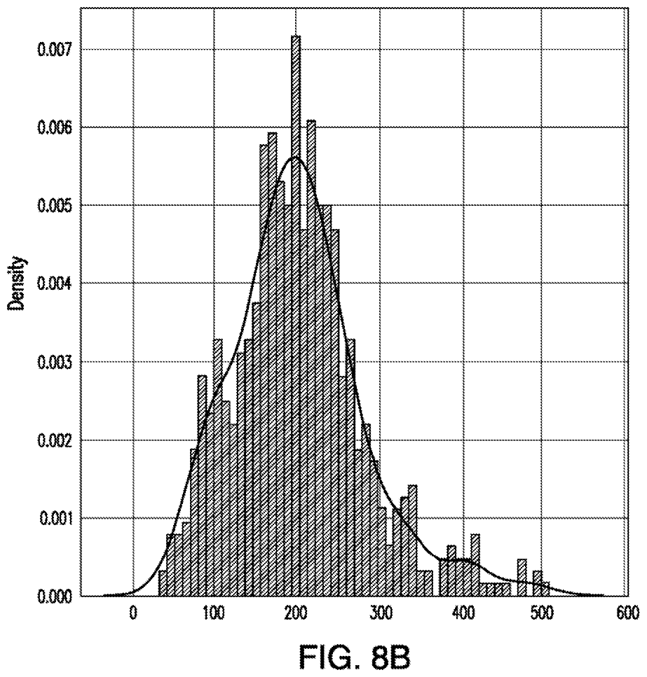

FIG. 7 illustrates graphs showing a node, with a good backhaul. FIGS. 8A and 8B illustrates graphs showing the CDF in FIG. 8A and the PDF in FIG. 8B. The graph in FIG. 8A shows the CDF of max-throughput observations, the node capacity is shown as a black dashed vertical line to the right. The two gray dashed vertical lines shows the interval [0.95Gₘₐₓ, Gₘₐₓ] and the emphasized part of the CDF in-between, equal to

$$Prob ( z \geq 0.95 {G}_{max} ) \approx \frac{1}{300} .$$

The graph in FIG. 8B shows the complete node PDF. It is immediately noted that the number of observations are few in FIG. 8A. This implies a low probability which is also seen in the pdf graph in FIG. 8B.

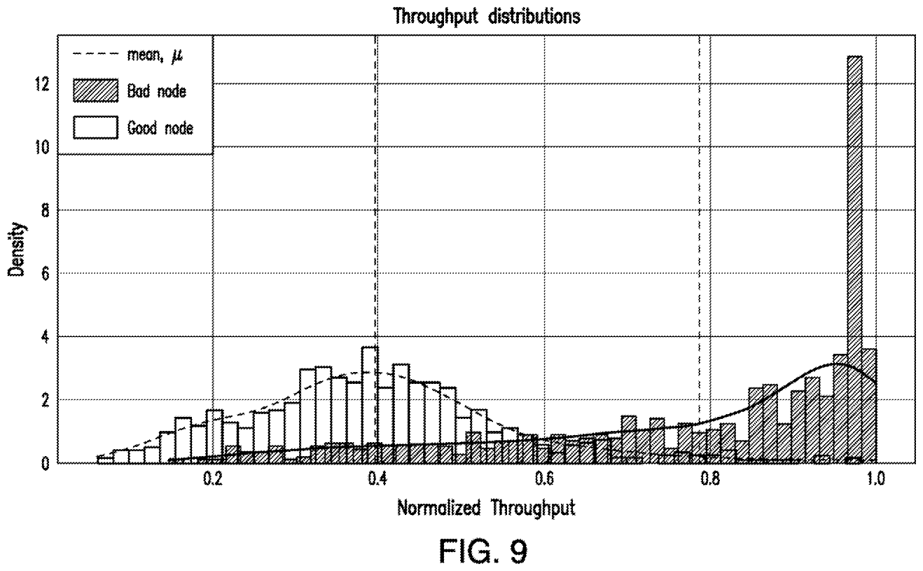

The two nodes can be compared in terms of their pdfs. FIG. 9 illustrates a graph showing the two pdfs, since the two nodes are using different maximum throughputs that quantity has been normalized with their Gₘₐₓ. To the left the non-capacity limited node is depicted with its normalized mean value as a dashed line. The capacity limited node is depicted to the right with its mean value. The limitation/saturation causes the pdf to skew to the right. In some embodiments, the skewness towards the right may indicate a capacity limitation.

Formally, the quantity that is of interest here is

$${p}_{m a s s} = Prob ( z > c {G}_{max} ) \qquad ( 9 )$$

where c is a constant and Gₘₐₓ is the maximum observed throughput. In some embodiments, c may be constant in any interval from 0 to 1. Equation (9) is simply the probability mass of throughput observations in the interval [cGₘₐₓ, Gₘₐₓ]. An approximation of equation 9 is the number of observations in that interval [cGₘₐₓ, Gₘₐₓ] divided by the total number of observations.

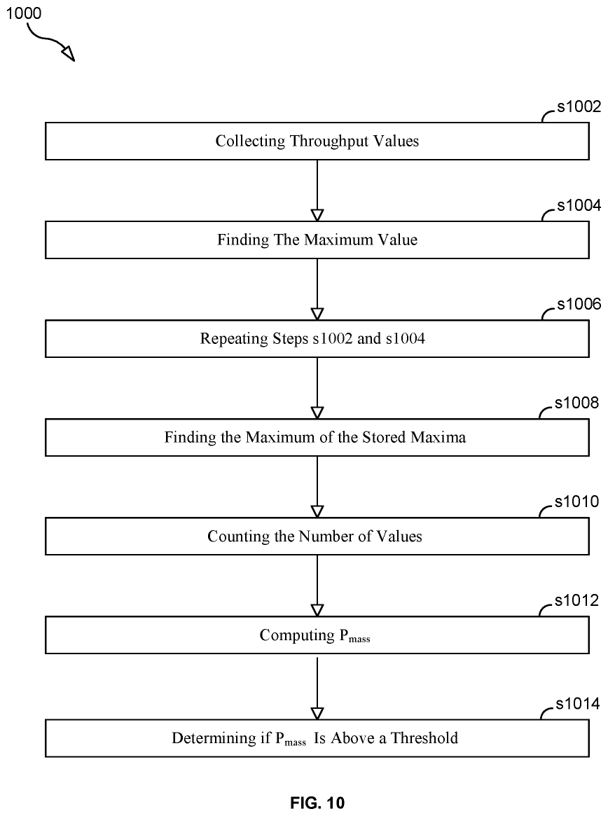

FIG. 10 is a flowchart illustrating a process 1000, according to an embodiment, to indicate if a device may be limited. Process 1000 may begin in step s1002. Step s1002 comprises collecting throughput values for a period T. Step s1004 comprises finding the maximum value and storing it. Step s1006 comprises repeating steps s1002 and s1004 for N number of times. Step s1008 comprises finding the maximum of the stored maxima, Gₘₐₓ. Step s1010 comprises counting the number of values, M, above the throughput cGₘₐₓ, alternatively, above the throughput c\tilde{G}ₘₐₓ where \tilde{G}ₘₐₓ is the 99^{th} percentile of stored maxima. In one embodiment of process 1000 the node reports the maximum throughput observed during a ROP.

Step s1012 comprises computing Pmass using equation (9) where

$${p}_{m a s s} = Prob ( z > c {G}_{max} ) \approx \frac{M}{N} .$$

Step s1014 comprises sending an indication that the node may be limited if pₘₐₛₛ is above the threshold pₘₐₓ. In some embodiments, an alarm may be sent as a result of determining Pₘₐₛₛ is above the threshold pₘₐₓ.

In step s1010, an optional modification can be made and it relates to the selection of data: The modification is essentially to lower the value Gₘₐₓ (maximum of all maximum throughputs). Instead, Gₘₐₓ is taken to be the value, \tilde{G}ₘₐₓ, found in the CDF position [0.99N], the 99th percentile, this removes the top 1% of values assuming they not being representative (e.g., noisy measurement or an outlier). In principle, this corresponds to using a different c-value in equation (9), and it will be unique to the specific device. Hence, the main advantage is that c does not have to be recomputed for each device, rather Gₘₐₓ is.

The pdf counter ifInOctetRatePercentiles provides seven values representing the Ethernet ingress throughput at the percentiles P₀, P₉₅, P₉₆, P₉₇, P₉₈, P₉₉, and P₁₀₀. The counter is reported as a vector of seven values and created in the node.

In some embodiments, the creation of a pdf counter ifInOctetRatePercentiles may comprise a number of steps. The number of received octets is assumed to be in a register CNT. This counter is incremented for each ingress octet and assumed to be zeroed at the start of a ROP. A register prevCNT will hold the previous count of CNT and is initialized to zero. The results are reported once a second and the difference between CNT and prevCNT is recorded in a vector P (t), where t represents the timing within a ROP. In some embodiments, these recordings are updated once per second and hence represent the number of octets per second, throughput. After each reported value preCNT is set to be equal to the current value of CNT. This vector is termed Fill and at the end of a ROP it contains 900 throughput measurements. These 900 measurements are sorted and used to report the seven percentiles which are determined and reported.

The pdf counter ifInOctetRatePercentiles may be reported to a dedicated server either in a cloud, or to another storage server. In some embodiments, multiple nodes may perform the operations described herein and report pdf counter ifInOctetRatePercentiles.

The procedure above may be employed at a facility for a period, for example a week resulting in N=672 values each representing the max throughput during T=15 minute periods. The max value for a 15 minute period is stored in ifInOctetRateMax. After N values have been collected equation (9) is computed using an appropriate value of c, say 0.95. In case the computed probability is above a threshold pₘₐₓ, for example, 0.3, an alarm is sent to notify that the backhaul needs attention.

In a second embodiment, the procedure may reside within the node. In such realization the throughput sampling period can be chosen differently. In one embodiment the throughput was sampled every second, Ts=1, and after a period of 15 minutes a max value was computed. In another embodiment the sampling time can be lower, for example Ts=0.1 (T=90 seconds). This implies that 672 max values can be computed in 16.8 hours instead of seven days. In addition, the computation is carried out on the node and reduces the need for computations at a central location. Moreover, the node itself can send an alarm to another device.

The condition for sending an alarm may also be subject to the limiting throughput speed, Gₘₐₓ, and the throughput capacity of the node, Cₘₐₓ. An alarm may be suppressed in case the limiting throughput is within a predetermined value from the node throughput capacity.

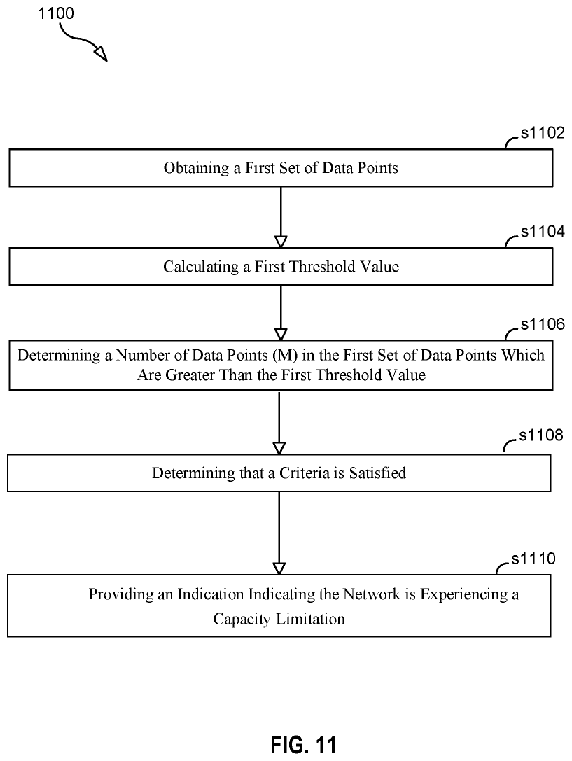

FIG. 11 is a flowchart illustrating a process 1100, according to an embodiment, for detecting whether a network is experiencing a capacity limitation. In some embodiments, the process 1100 may be performed by a digital unit, a node, radio base station, or any other device or piece of equipment in a network. In yet another embodiment, the process 1100 may be performed on a separate device from the limited device, such as a data center. Process 1100 may begin in step s1102.

Step s1102 comprises obtaining a first set of data points. Each data point in the first set of data points is a throughput value for a network node (e.g., a maximum throughput value).

Step s1104 comprises, based on the first set of data points, calculating a first threshold value.

Step s1106 comprises determining a number of data points (M) in the first set of data points which are greater than the first threshold value.

Step s1108 comprises determining that a criteria (the criteria may include one or

more criterions) is satisfied.

Step s1110 comprises, as a result of determining that the criteria is satisfied, providing an indication (e.g., transmitting an alarm message) indicating the network is experiencing a capacity limitation, wherein determining that the criteria is satisfied comprises determining that M satisfies a first condition.

In some embodiments, determining that M satisfies the first condition comprises: determining that M is greater than N×T2, where N is the total number of data points in the first set of data points or N is a function of the total number of data points in the first set of data points and T2 is a predetermined threshold.

In some embodiments, calculating the first threshold comprises: selecting a value from the first set of data points, wherein the selected value is either the largest value included in the first set of data point or the nth largest value included in the first set of data points; and calculating the first threshold (T1) using the selected value and a predetermined value, C (e.g., calculating T1=C×Gmax, where Gmax is the selected value).

In some embodiments, determining that the criteria is satisfied further comprises determining that the selected value satisfies a second condition.

In some embodiments, the criteria is satisfied if: M satisfies the first condition, and the selected value satisfies the second condition.

In some embodiments, determining that the selected value satisfies the second condition comprises determining that the selected value is less than a second threshold, and the second threshold is a function of a maximum throughput capacity, Cmax, of the network node or the second threshold is Cmax. In other embodiments, the indication (e.g., transmitting an alarm message) may be suppressed if (Cₘₐₓ−Gₘₐₓ)<ΔG, where ΔG is a fraction of Cₘₐₓ. In such embodiments, the indication may be provided if Pₘₐₛₛ is above the threshold pₘₐₓ and (Cₘₐₓ−Gₘₐₓ)>ΔG.

In some embodiments, the selected value is nth largest value included in the first set of data points, n=floor/ceiling (N×.01), and N is the total number of data points in the first set of data points.

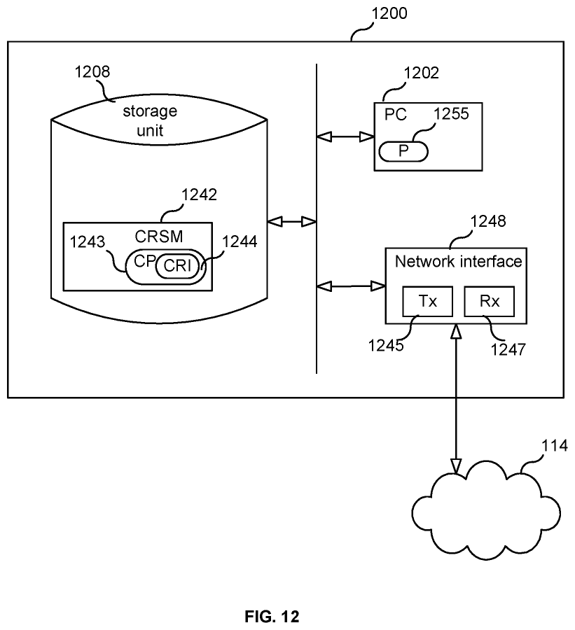

FIG. 12 is a block diagram of an apparatus 1200 for implementing a node (e.g., node 102), according to some embodiments. As shown in FIG. 12, apparatus 1200 may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 1200 may be a distributed computing apparatus); at least one network interface 1248 (e.g., a physical interface or air interface) comprising a transmitter (Tx) 1245 and a receiver (Rx) 1247 for enabling apparatus 1200 to transmit data to and receive data from other nodes connected to a network 114 (e.g., an Internet Protocol (IP) network) to which network interface 1248 is connected (physically or wirelessly) (e.g., network interface 1248 may be coupled to an antenna arrangement comprising one or more antennas for enabling encoder apparatus 1200 to wirelessly transmit/receive data); and a storage unit (a.k.a., “data storage system”) 1208, which may include one or more non-volatile storage devices and/or one or more volatile storage devices. In embodiments where PC 1202 includes a programmable processor, a computer readable storage medium (CRSM) 1242 may be provided. CRSM 1242 may store a computer program (CP) 1243 comprising computer readable instructions (CRI) 1244. CRSM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes encoder apparatus 1200 to perform the steps described herein (e.g., steps described herein with reference to the flow charts). In other embodiments, encoder apparatus 1200 may be configured to perform the steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other devices are used to relay the message from the source device to the intended recipient). Likewise, as used herein receiving a message “from” a sender encompasses receiving the message directly from the sender or indirectly from the sender (i.e., one or more devices are used to relay the message from the sender to the receiving device). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for detecting whether a network is experiencing a capacity limitation, the method comprising:
obtaining a first set of data points, wherein each data point in the first set of data points is a throughput value for a network node;
based on the first set of data points, calculating a first threshold value;
determining a number of data points (M) in the first set of data points which are greater than the first threshold value;
determining that a criteria is satisfied; and
as a result of determining that the criteria is satisfied, providing an indication indicating the network is experiencing a capacity limitation, wherein
determining that the criteria is satisfied comprises determining that M satisfies a first condition.

2. The method of claim 1, wherein determining that M satisfies the first condition comprises:
determining that M is greater than N×T2, where N is the total number of data points in the first set of data points or N is a function of the total number of data points in the first set of data points and T2 is a predetermined threshold.

3. The method of claim 1, wherein calculating the first threshold comprises:
selecting a value from the first set of data points, wherein the selected value is either the largest value included in the first set of data point or the nth largest value included in the first set of data points; and
calculating the first threshold (T1) using the selected value and a predetermined value, C.

4. The method of claim 3, wherein determining that the criteria is satisfied further comprises determining that the selected value satisfies a second condition.

5. The method of claim 4, wherein the criteria is satisfied if:
M satisfies the first condition, and
the selected value satisfies the second condition.

6. The method of claim 4, wherein
determining that the selected value satisfies the second condition comprises determining that the selected value is less than a second threshold, and
the second threshold is a function of a maximum throughput capacity, Cmax, of the network node or the second threshold is Cmax.

7. The method of claim 3, wherein
the selected value is nth largest value included in the first set of data points,
n=floor/ceiling (N×.01), and
N is the total number of data points in the first set of data points.

8-9. (canceled)

10. A non-transitory computer readable storage medium storing a computer program comprising instructions, executable by processing circuitry of an apparatus, for configuring the apparatus to perform the method of claim 1.

11. An apparatus, the apparatus being configured to perform a process comprising:
obtaining a first set of data points, wherein each data point in the first set of data points is a throughput value for a network node;
based on the first set of data points, calculating a first threshold value;
determining a number of data points (M) in the first set of data points which are greater than the first threshold value;
determining that a criteria is satisfied; and
as a result of determining that the criteria is satisfied, providing an indication indicating the network is experiencing a capacity limitation, wherein
determining that the criteria is satisfied comprises determining that M satisfies a first condition.

12. The apparatus of claim 11, wherein determining that M satisfies the first condition comprises:
determining that M is greater than N×T2, where N is the total number of data points in the first set of data points or N is a function of the total number of data points in the first set of data points and T2 is a predetermined threshold.

13. The apparatus of claim 11, wherein calculating the first threshold comprises:
selecting a value from the first set of data points, wherein the selected value is either the largest value included in the first set of data point or the nth largest value included in the first set of data points; and
calculating the first threshold (T1) using the selected value and a predetermined value, C.

14. The apparatus of claim 13, wherein determining that the criteria is satisfied further comprises determining that the selected value satisfies a second condition.

15. The apparatus of claim 14, wherein the criteria is satisfied if:
M satisfies the first condition, and
the selected value satisfies the second condition.

16. The apparatus of claim 14, wherein
determining that the selected value satisfies the second condition comprises determining that the selected value is less than a second threshold, and
the second threshold is a function of a maximum throughput capacity, Cmax, of the network node or the second threshold is Cmax.

17. The apparatus of claim 13, wherein
the selected value is nth largest value included in the first set of data points,
n=floor/ceiling (N×.01), and
N is the total number of data points in the first set of data points.
